(19) United States
(12) Patent Application Publication
(10) Pub. No.: US 2008/0307029 A1
(43) Pub. Date: Dec. 11, 2008

(54) Arithmetic device and arithmetic method

(75) Inventor: Ryuji Kan, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/222,521

(22) Filed: Aug. 11, 2008

Related U.S. Application Data
(63) Continuation of application No. PCT/JP2006/302534, filed on Feb. 14, 2006.

(51) Int. Cl. G06F 7/42; G06F 7/44

(52) U.S. Cl. 708/503; 708/505

(57) ABSTRACT

An FMA arithmetic unit has a timing control circuit. The timing control circuit controls bypass selectors to bypass intermediate resisters on performing floating point addition/subtraction, controls another bypass selector to bypass another intermediate register on performing floating point multiplication, and controls still another bypass selectors to bypass a register file/other arithmetic unit result register and operand registers on performing successive FMA arithmetic operations.

### BACKGROUND OF THE INVENTION

1. Field of the Invention

The present invention relates to an arithmetic device which performs addition, subtraction, and multiplication of numbers represented by floating points and an arithmetic method thereof.

2. Description of the Related Art

In recent years, due to rapid spread of multimedia, TV games using delicate graphics, and the like, or other reasons, it is required to provide a customer with high-quality computer graphics and the like used in multimedia, TV games, and the like.

In order to meet such a demand, realization of a high-speed floating point multiplication and addition arithmetic unit is desired. A configuration of a conventional floating point multiplication and addition arithmetic unit (referred to below as “FMA arithmetic unit”) is explained below in a concrete manner. FIG. 6 is a block diagram of the conventional FMA arithmetic unit.

As shown in FIG. 6, the FMA arithmetic unit is provided with a register file/other arithmetic unit result register 10, selectors 20 to 25, operand registers 30 to 32, format converters 40 to 43, intermediate registers 50 to 60, a Booth encode circuit 70, a CSA arithmetic unit 80, an adder 90, a digit adjusting shifter 100, an absolute value adder 110, a normalization shifter 120, a rounding arithmetic unit 130, and a result register 140.

Of the configuration, the register file/other arithmetic unit result register 10 is a storing device which temporarily stores data for an arithmetic operation (such data is referred to below as “operand”), and the selectors 20 to 22 are devices which select operands from the register file/other arithmetic unit result register 10 or the result register 140 (result register 140 is a storing device which stores results of arithmetic operations) and store the selected operands in the operand registers 30 to 32, respectively.

The operand registers 30 to 32 are devices which stores an operand selected by the selectors 20 to 22, respectively. The selectors 23 to 25 are devices which select an operand stored in the operand registers 30 to 32 or the result register 140, and input the selected operand to the format converters 40 to 42, respectively.

The format converters 40 to 42 are devices which convert the format of the operand that is input by the selectors 23 to 25, into a format for an execution of the floating point multiplication and addition arithmetic operation (i.e., the format converters are devices which convert an external format into an internal format of the FMA arithmetic unit). The format converters 40 to 42 store the operands whose format has been converted (such operand is referred to below as “format converted operand”) in the intermediate registers 50 to 52, respectively. The intermediate registers 50 to 60 are devices which temporarily store data (the intermediate registers 50 to 52 store a format converted operand).

The Booth encode circuit 70 is a device which acquires the format converted operand stored in the intermediate register 51 to perform a second-order Booth encode according to the Booth's algorithm on the format converted operand (the format converted operand stored in the intermediate register 51 is set as a multiplier). Then, the Booth encode circuit 70 stores the format converted operand, on which the second-order Booth encode has been performed, in the intermediate register 54.

The CSA (Carry Save Adder) arithmetic unit 80 is a device which acquires the format converted operand which is stored in the intermediate register 53 (the format converted operand stored in the intermediate register 50 is subsequently stored in the intermediate register 53) (the format converted operand stored in the intermediate register 53 is set as a multiplicand), and also acquires the data, on which the second-order Booth encode is performed, stored in the intermediate register 54, then, calculates a partial product (when the multiplier and the multiplicand are 64-bit each, 32 partial products are calculated), and adds each of the calculated partial products.

The adder 90 is a device which adds the sum of partial products calculated by the CSA arithmetic unit 80, and the value of a carry given by the addition of each partial product (the adder 90 is a device which absorbs the carry of the CSA arithmetic unit 80). Then, the adder 90 stores the result of addition in the intermediate register 57. In short, the multiplication of the multiplicand stored in the intermediate register 50 and the multiplier stored in the intermediate register 51 is performed through the Booth encode circuit 70, the CSA arithmetic unit 80, and the adder 90.

The digit adjusting shifter 100 is a device which acquires the format converted operand stored in the intermediate register 52, and performs digit adjusting of the acquired format converted operand. The digit adjusting shifter 100 stores the format converted operand after the digit adjusting in the intermediate register 55 (the data stored in the intermediate register 55 is subsequently stored in the intermediate register 56). The digit adjusting shifter 100 performs the digit adjusting of the format converted operand stored in the intermediate register 52, which allows the values stored in the intermediate register 57 and the intermediate register 56 to be properly added.

The absolute value adder 110 is a device which adds the value stored in the intermediate register 56 and the value stored in the intermediate register 57. Further, the absolute value adder 110 stores the result of addition in the intermediate register 58.

The normalization shifter 120 is a device which normalizes the value stored in the intermediate register 58. Further, the normalization shifter 120 stores the normalized value in the intermediate register 59. The rounding arithmetic unit 130 is a device which acquires the value stored in the intermediate register 59, and performs a rounding operation (i.e. round-off, round-up, round-down and the like) on the acquired value. Further, the rounding arithmetic unit 130 stores the value, on which a rounding operation has been performed, in the intermediate register 60.

The format converter 43 is a device which converts the format of the data (i.e. the value) stored in the intermediate register 60 into the format to be stored in the result register 140 (in other words, the format converter 43 is a device which converts the internal format into the external format). The format converter 43 performs an inverse conversion of the format conversion performed by the format converters 40 to 42. The format converter 43 stores the data, the format of which is converted, i.e., the result of the FMA arithmetic operation, in the result register 140.

Conventionally, floating point addition/subtraction and floating point multiplication are performed with the use of the FMA arithmetic unit described above. Now, floating point addition/subtraction and floating point multiplication are described below with reference to FIG. 6. When the floating point addition/subtraction is performed with the use of the FMA arithmetic unit, of two operands on which the addition is performed, one operand is stored in the operand register 30, the other operand is stored in the operand register 32, and “1” is set in the operand register 31.

Since “1” is stored in the operand register 31, the operand stored in the operand register 30, after being subjected to format conversion in the format converter 40, is stored as it is in the intermediate register 57. Thus, the FMA arithmetic unit can perform the floating point addition/subtraction by adding the value stored in the intermediate register 57 and the value stored in the intermediate register 56 by the absolute value adder 110.

On the other hand, when the floating point multiplication is performed with the use of the FMA arithmetic unit, the operand of the multiplicand is stored in the operand register 30, the multiplier is stored in the operand register 31, and “0” is stored in the operand register 32.

When “0” is stored in the operand register 32, “0” is added to the result of multiplication of the multiplicand stored in the operand register 30 and the multiplier stored in the operand register 31 (in other words, “0” is added to the result of multiplication by the absolute value adder 110). Thus, the FMA arithmetic unit can perform the floating point multiplication.

Meanwhile, according to a technology described in Japanese Patent Application Laid-Open No. S59-106043, a register arranged between combinational logic circuits is bypassed in an execution of a one-time arithmetic operation, so that the register is substantially eliminated and an arithmetic operation time is shortened.

When the floating point addition/subtraction or the floating point multiplication is performed in the FMA arithmetic unit described with reference to FIG. 6, however, some parts of the FMA arithmetic unit are not necessary. Thus, the floating point addition/subtraction and the floating point multiplication are not performed efficiently.

Specifically, when the floating point addition/subtraction is performed, the arithmetic operations in the Booth encode circuit 70, the CSA. arithmetic unit 80, and the adder 90 are redundant. On the other hand, when the floating point multiplication is performed, the arithmetic operations in the digit adjusting shifter 100, the absolute value adder 110, and the normalization shifter 120 are redundant.

### SUMMARY OF THE INVENTION

It is an object of the present invention to at least partially solve the problems in the conventional technology.

According to one aspect of the present invention, an arithmetic device which performs one of addition/subtraction and multiplication of numbers represented by floating points, includes an addition/subtraction unit that performs addition/subtraction of numbers, a multiplication unit that performs multiplication of numbers, and a selection unit that selects one of the addition/subtraction unit and the multiplication unit based on a type of an arithmetic operation on numbers.

Further, according to another aspect of the present invention, an arithmetic method for performing one of addition/subtraction and multiplication of numbers represented by floating points, includes acquiring information on a type of an arithmetic operation performed on the numbers, and selecting one of an addition/subtraction unit that performs addition/subtraction of numbers and a multiplication unit that performs multiplication of numbers based on the type of the arithmetic operation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration of an information processing device including an FMA arithmetic unit according to the embodiment of the present invention;

FIG. 2 is a block diagram of the FMA arithmetic unit according to the embodiment of the present invention;

FIG. 3 is a diagram showing an effect of shortening of an arithmetic latency in floating point addition/subtraction;

FIG. 4 is a diagram showing an effect of shortening of an arithmetic latency in floating point multiplication;

FIG. 5 is a diagram showing an effect of shortening of an arithmetic latency in successive FMA arithmetic operations; and

FIG. 6 is a block diagram of a conventional FMA arithmetic unit.

### DETAILED DESCRIPTION OF THE PREFERRED EMBODIMENTS

Exemplary embodiments of an arithmetic device and an arithmetic method according to the present invention are described below in detail with reference to the drawings. The present invention is not limited to the embodiments.

The present invention shortens an arithmetic latency in floating point addition/subtraction and floating point multiplication in a floating point multiplication and addition arithmetic unit (i.e., FMA arithmetic unit) and in executing an arithmetic operation using a result of previous arithmetic operation as an operand in the FMA arithmetic unit, by bypassing a redundant part of the FMA arithmetic unit.

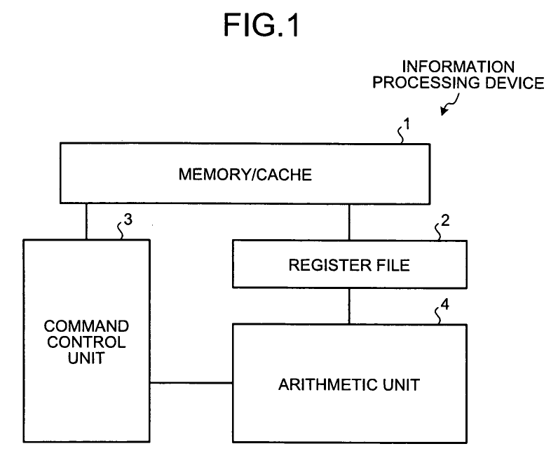

FIG. 1 is a diagram of a configuration of an information processing device including an FMA arithmetic unit according to the embodiment of the present invention. As shown in FIG. 1, the information processing device has a memory/cache 1, a register file 2, a command control unit 3, and an arithmetic unit 4. Of these, the memory/cache 1 is a device which stores a command and data, the register file 2 is a device which temporarily stores a result of arithmetic operation by the arithmetic unit 4 and data transferred from the memory/cache 1.

The command control unit 3 is a device which acquires a command stored in the memory/cache 1, interprets the command, and issues a predetermined arithmetic command to the arithmetic unit 4. The arithmetic unit 4 is a device which executes a predetermined arithmetic operation in response to the arithmetic command from the command control unit 3. The FMA arithmetic unit according to the present embodiment is included in the arithmetic unit 4.

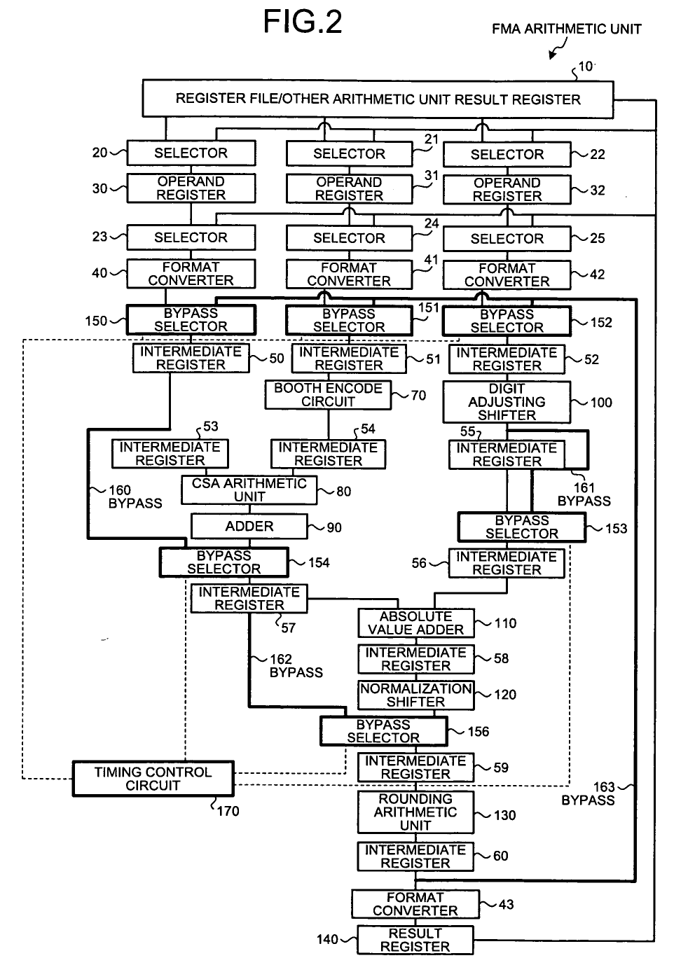

FIG. 2 is a block diagram of the FMA arithmetic unit according to the present embodiment. As shown in FIG. 2, the FMA arithmetic unit has a register file/other arithmetic unit result register 10, selectors 20 to 25, operand registers 30 to 32, format converters 40 to 43, intermediate registers 50 to 60, a Booth encode circuit 70, a CSA arithmetic unit 80, an adder 90, a digit adjusting shifter 100, an absolute value adder 110, a normalization shifter 120, a rounding arithmetic unit 130, a result register 140, bypass selectors 150 to 154 and 156, bypasses 160 to 163, and a timing control circuit 170.

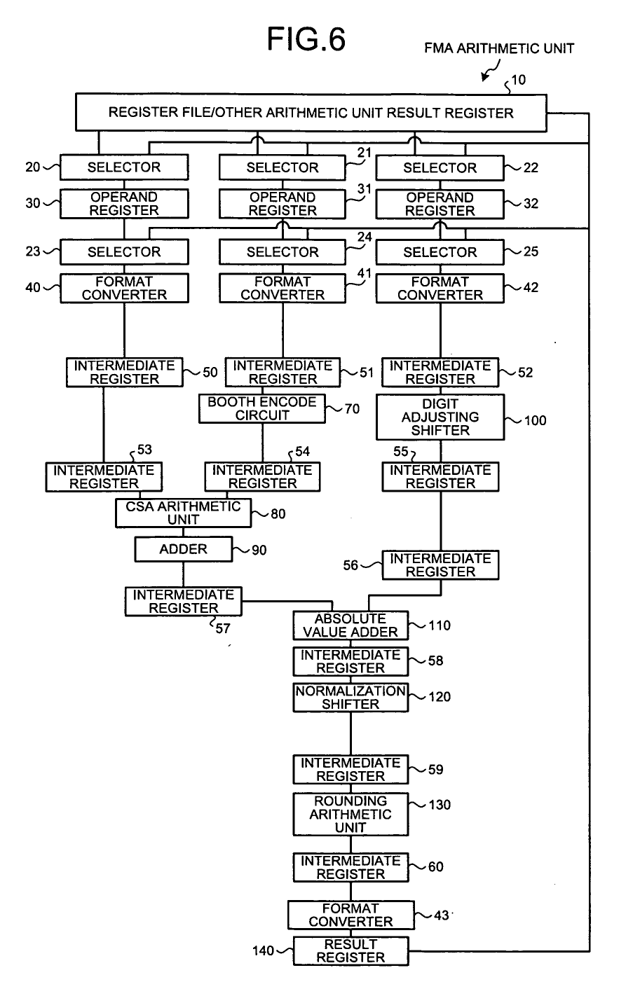

Of the above configuration, the register file/other arithmetic unit result register 10, the selectors 20 to 25, the operand registers 30 to 32, the format converters 40 to 43, the intermediate registers 50 to 60, the Booth encode circuit 70, the CSA arithmetic unit 80, the adder 90, the digit adjusting shifter 100, the absolute value adder 110, the normalization shifter 120, the rounding arithmetic unit 130, and the result register 140 are the same with the corresponding elements in the FMA arithmetic unit shown in FIG. 6. Therefore, the same numeral is attached to the same element and the description thereof is not repeated.

The bypass selectors 150 to 154, and 156 are devices which select/acquire data according to the command from the timing control circuit 170. The bypasses 160 to 163 are bypasses used by the bypass selectors 150 to 154, and 156 in order to eliminate redundant operations in the FMA arithmetic unit.

The timing control circuit 170 is a device which controls the bypass selectors 150 to 154, and 156 to bypass redundant parts of the FMA arithmetic unit based on the contents of arithmetic operation (i.e., depending on whether the FMA arithmetic unit performs the floating point addition/subtraction or the floating point multiplication, or, whether the FMA arithmetic unit uses a result of previous arithmetic operation in a subsequent arithmetic operation). Further, the timing control circuit 170 acquires information indicating contents of arithmetic operation from the command control unit 3 shown in FIG. 1. Hereinafter, the processes performed by the timing control circuit 170 on executing the floating point addition/subtraction, the floating point multiplication, and an arithmetic operation using a result of previous arithmetic operation are described separately in this order.

Firstly, the process performed by the timing control circuit 170 when the FMA arithmetic unit performs the floating point addition/subtraction is described. When the conventional technique is employed for the floating point addition/subtraction, an arithmetic latency is as long as that in the FMA arithmetic operation. Here, the Booth encode circuit 70, the CSA arithmetic unit 80, and the adder 90 are not necessary for the floating point addition/subtraction in the FMA arithmetic unit. Therefore, the timing control circuit 170, when performing the floating point addition/subtraction, controls the bypass selectors 153 and 154 to bypass the intermediate registers 53 and 55.

The bypass selector 154 acquires a format converted operand stored in the intermediate register 50 via the bypass 160 and stores the acquired format converted operand in the intermediate register 57, whereas the bypass selector 153 acquires a format converted operand for which the digit adjusting is performed by the digit adjusting shifter 100 via the bypass 161 and stores the acquired format converted operand as it is in the intermediate register 56.

As described above, in the execution of floating point addition/subtraction, the timing control circuit 170 controls the bypass selectors 153, 154 and bypasses the intermediate registers 53, 55, thereby making it possible to shorten the arithmetic latency. Further, as the operand stored in the intermediate register 50 (the operand stored in the operand register 30) can be selected by the bypass selector 154, it is not necessary to store “1” in the operand register 31 in the execution of floating point addition/subtraction, whereby the selection logic of the operand register can be simplified.

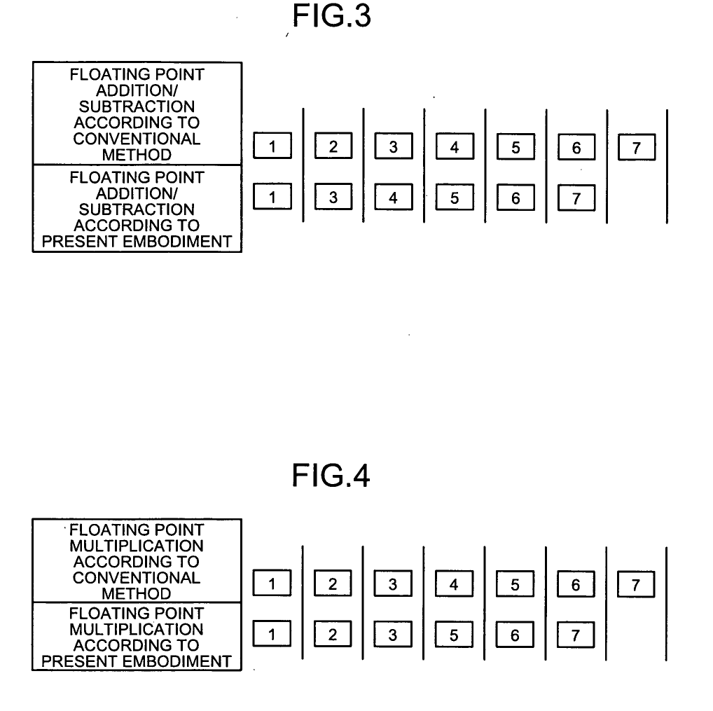

FIG. 3 is a diagram showing an effect of shortening of the arithmetic latency in the floating point addition/subtraction. Each of numerals 1 to 7 in FIG. 3 represents timing the data in the operand registers 30 to 32 reach the different intermediate register.

1: Intermediate registers 50, 51, 52
2: Intermediate registers 53, 54, 55
3: Intermediate registers 56, 57
4: Intermediate register 58
5: Intermediate register 59
6: Intermediate register 60
7: Result register 140

As shown in FIG. 3, while the floating point addition/subtraction according to the conventional technique requires all of the timings 1 to 7, the floating point addition/subtraction according to the present embodiment bypasses the intermediate registers 53, 55, and thus no longer requires the timing “2”, thereby making it possible to shorten the arithmetic latency. The timing control circuit 170 controls the bypass selector 154 to select the bypass 160, and the bypass selector 153 to select the bypass 161 at the timing “3” in the lower line of FIG. 3.

Secondly, the process performed by the timing control circuit 170 when the FMA arithmetic unit performs the floating point multiplication is described. When the conventional technique is employed for the floating point multiplication, an arithmetic latency is as long as that in the FMA arithmetic operation. Here, the digit adjusting shifter 100, the absolute value adder 110, and the normalization shifter 120 are not necessary for the floating point multiplication in the FMA arithmetic unit. Therefore, the timing control circuit 170, when performing the floating point multiplication, controls the bypass selector 156 to bypass the intermediate register 58.

The bypass selector 156 acquires data (i.e. result of multiplication) stored in the intermediate register 57 through the bypass 162, and stores the acquired data in the intermediate register 59.

As described above, in the execution of floating point multiplication, the timing control circuit 170 controls the bypass selector 156 and bypasses the intermediate register 58, thereby making it possible to shorten the arithmetic latency. Further, the bypass selector 156 acquires the data of the result of multiplication stored in the intermediate register 57, and does not acquire the result of addition in the absolute value adder 110. Thus it is not necessary to store “0” in the operand register 32, whereby the selection logic of the operand register can be simplified.

FIG. 4 is a diagram of an effect of shortening of the arithmetic latency in the floating point multiplication. Numerals 1 to 7 in FIG. 4 are the same as the numerals in FIG. 3. As shown in the FIG. 4, while the floating point multiplication according to the conventional technique requires all of the timings 1 to 7, the floating point multiplication according to the present embodiment bypasses the intermediate register 58, and thus no longer requires the timing “4”, thereby making it possible to shorten the arithmetic latency. The timing control circuit 170 controls the bypass selector 156 to select the bypass 162 at the timing “5” in the lower line of FIG. 4.

Thirdly, the process performed by the timing control circuit 170 when a result of previous FMA arithmetic operation is employed in a subsequent arithmetic operation, i.e., in successive FMA arithmetic operations, is described. Even in the successive FMA arithmetic operations, according to the conventional technique, the subsequent FMA arithmetic operation is executed after data is transferred to the format converters 40 to 42 from the result register 140 through the register file/other arithmetic unit result register 10, or through the selectors 20 to 22 and operand registers 30 to 32, or through the selectors 23 to 25.

In these cases, the format converter 43 converts the internal format into the external format in the first arithmetic operation, and the format converters 40 to 42 convert the external format back into the internal format in the subsequent arithmetic operation. To eliminate such a redundant operation, the timing control circuit 170, in performing successive FMA arithmetic operations, controls the bypass selectors 150 to 152 to bypass the register file/other arithmetic unit result register 10 and the operand registers 30 to 32.

Then, the bypass selectors 150 to 152 acquire the data stored in the intermediate register 60 via the bypass 163, and store the acquired data as it is in the intermediate registers 50 to 52, respectively.

Thus, in the execution of successive FMA arithmetic operations, the timing control circuit 170 controls the bypass selectors 150 to 152 and bypasses the register file/other arithmetic unit result register 10, the operand registers 30 to 32, thereby making it possible to shorten the arithmetic latency.

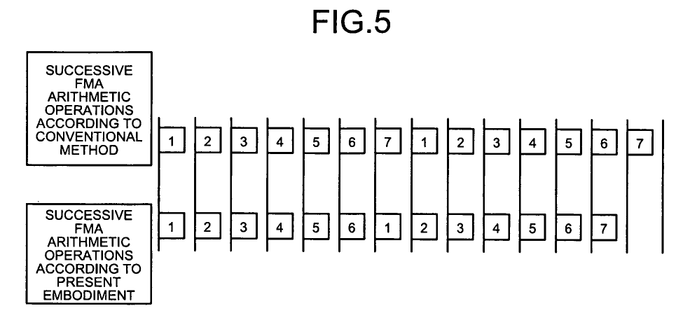

FIG. 5 is a diagram showing an effect of shortening of the arithmetic latency in the successive FMA arithmetic operations. Numerals 1 to 7 shown in FIG. 5 are the same as the numerals in FIG. 3. As shown in FIG. 5, while the successive FMA arithmetic operations according to the conventional technique require all of the timings 1 to 7, the successive FMA arithmetic operations according to the present embodiment bypasses the register file/other arithmetic unit result register 10, and the operand registers 30 to 32, and thus no longer requires the timing “7” in a first cycle, thereby making it possible to shorten the arithmetic latency. The timing control circuit 170 controls the bypass selectors 150 to 152 to select the bypass 163 at the timing “1” in the second cycle as represented by the lower line in FIG. 5.

The timing control circuit 170 controls the bypass selectors 150 to 152 to select the bypass 163 at the timing “7” in the first cycle. When the FMA arithmetic operations continues further, the timing control circuit 170 controls the bypass selectors 150 to 152 to select the bypass 163, at the timing “7” in a second, a third, to an n-th cycle.

The technique of bypassing the register file/other arithmetic unit result register 10 and the operand registers 30 to 32 in the successive FMA arithmetic operations may be used in the floating point addition/subtraction or the floating point multiplication as described above.

For example, when arithmetic operations of the floating point addition/subtraction are performed successively, the timing “7” as well as the timing “2” shown in FIG. 5 may be omitted, so that the arithmetic latency is shortened. Likewise, when arithmetic operations of the floating point multiplication are performed successively, the timing “7” as well as the timing “4” shown in FIG. 5 may be omitted, so that the arithmetic latency is shortened. Further, in floating point multiplication using the result of floating point addition/subtraction, or in floating point addition/subtraction using the result of floating point multiplication, the timing “7” can be omitted, so that the arithmetic latency is shortened.

As described above, the FMA arithmetic unit according to the present embodiment has the timing control circuit 170, which controls the bypass selectors 153, 154 to bypass the intermediate resisters 53, 55 in the execution of floating point addition/subtraction, the bypass selector 156 to bypass the intermediate register 58 in the execution of floating point multiplication, and the bypass selectors 150 to 152 to bypass the register file/other arithmetic unit result register 10 and the operand registers 30 to 32 in the execution of successive FMA operations, thereby shortening the arithmetic latency and enabling an effective execution of floating point addition/subtraction, floating point multiplication and the like.

According to the embodiment of the present invention, one of the addition/subtraction unit and the multiplication unit is selected based on the type of arithmetic operation performed on numbers represented by floating points, and the arithmetic operation is executed on the numbers with the use of the selected unit, whereby the arithmetic latency can be shortened.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An arithmetic device which performs one of addition/subtraction and multiplication of numbers represented by floating points, comprising:
an addition/subtraction unit that performs addition/subtraction of numbers;
a multiplication unit that performs multiplication of numbers; and
a selection unit that selects one of the addition/subtraction unit and the multiplication unit based on a type of an arithmetic operation on numbers.

2. The arithmetic device according to claim 1, wherein the addition/subtraction unit bypasses a number for addition/subtraction in order to acquire numbers for addition/subtraction at same timing.

3. The arithmetic device according to claim 1, further comprising
a bypass unit that bypasses a result of an arithmetic operation by the multiplication unit when the type of the arithmetic operation is multiplication so that the result of the arithmetic operation is not input to the addition/subtraction unit.

4. The arithmetic device according to claim 1 further comprising
a conversion unit that converts, when the arithmetic operation is performed, a data format of the number from an external format into an internal format of the arithmetic device, and
an inverse-conversion unit that converts, when a result of an arithmetic operation on numbers by the addition/subtraction unit or the multiplication unit is not used in a subsequent arithmetic operation, a data format of the result of the arithmetic operation from the internal format of the arithmetic device to the external format.

5. The arithmetic device according to claim 4, wherein
the addition/subtraction unit uses, when using a result of an arithmetic operation by the addition/subtraction unit or a result of an arithmetic operation by the multiplication unit in a subsequent addition/subtraction, the result of the arithmetic operation in the internal format in the subsequent addition/subtraction.

6. The arithmetic device according to claim 4, wherein
the multiplication unit uses, when using a result of an arithmetic operation by the addition/subtraction unit or a result of an arithmetic operation by the multiplication unit in a subsequent multiplication, the result of arithmetic operation in the internal format in the subsequent multiplication.

7. An arithmetic method for performing one of addition/subtraction and multiplication of numbers represented by floating points, comprising:
acquiring information on a type of an arithmetic operation performed on the numbers; and
selecting one of an addition/subtraction unit that performs addition/subtraction of numbers and a multiplication unit that performs multiplication of numbers based on the type of the arithmetic operation.

8. The arithmetic method according to claim 7, wherein
the addition/subtraction unit bypasses a number for addition/subtraction in order to acquire numbers for addition/subtraction at same timing.

9. The arithmetic method according to claim 7, further comprising
bypassing, when the multiplication unit is selected in the selecting, a result of an arithmetic operation by the multiplication unit so that the result of the arithmetic operation is not input to the addition/subtraction unit.

10. The arithmetic method according to claim 7 further comprising
converting, when the arithmetic operation is performed, a data format of the number from an external format into an internal format of an arithmetic device, and
inversely converting, when a result of an arithmetic operation of numbers by one of the addition/subtraction unit and the multiplication unit is not used in a subsequent arithmetic operation, a data format of the result of the arithmetic operation from the internal format of the arithmetic device to the external format.
